(19) United States
(12) Patent Application Publication
(10) Pub. No.: US 2024/0421682 A1
(43) Pub. Date: Dec. 19, 2024

(54) VIBRATION MODULE

(71) Applicant: NIDEC PRECISION CORPORATION, Tokyo (JP)

(72) Inventors: Zendi MORI, Tokyo (JP); Qiangqi YANG, Tokyo (JP); Zixi LI, Tokyo (JP)

(21) Appl. No.: 18/740,515

(22) Filed: Jun. 12, 2024

(30) Foreign Application Priority Data
Jun. 14, 2023 (JP) 2023-097362

(51) Int. Cl. H02K 33/06; H02K 33/16

(52) U.S. Cl. CPC H02K 33/06; H02K 33/16

(57) ABSTRACT

A vibration module includes a movable unit including a base plate, a magnet, and a back yoke, a stationary unit including a frame, a substrate, a coil, and an insulator, and an elastic member between the movable unit and the stationary unit. The movable unit, the stationary unit, and the elastic member are arranged in a first arrangement direction. The frame in the stationary unit has a first surface at one side of the frame in the first arrangement direction and attached to the movable unit with the elastic member, and the frame has a second surface at the other side of the frame in the first arrangement direction and attachable to a vibration body supported by a support. The movable unit is movable relative to the stationary unit in a second arrangement direction intersecting with the first arrangement direction.

### RELATED APPLICATIONS

The present application claims priority to Japanese Application Number 2023-097362, filed Jun. 14, 2023, the disclosure of which is hereby incorporated by reference herein in its entirety.

### BACKGROUND

### Technical Field

The present invention relates to a vibration module.

### Description of the Background

Laptop personal computers, tablet mobile information terminals, and other devices include known vibration actuators that generate vibration in response to a user operation.

Patent Literature 1 describes a vibration actuator including a yoke, a permanent magnet, and a plate that form a magnetic circuit in the vertical direction in which a central shaft extends. The vibration actuator generates vibration in the vertical direction in which the central shaft extends.

### CITATION LIST

### Patent Literature

Patent Literature 1: Japanese Unexamined Patent Application Publication No. 2000-4569

### BRIEF SUMMARY

However, a vibration actuator that vibrates in the horizontal direction upsizes a device.

A vibration module according to an aspect of the present invention includes a movable unit including a base plate, a magnet, and a back yoke, a stationary unit including a frame, a substrate, a coil, and an insulator, and an elastic member between the movable unit and the stationary unit. The movable unit, the stationary unit, and the elastic member are arranged in a first arrangement direction. The frame in the stationary unit has a first surface at one side of the frame in the first arrangement direction and attached to the movable unit with the elastic member, and the frame has a second surface at the other side of the frame in the first arrangement direction and attachable to a vibration body supported by a support. The movable unit is movable relative to the stationary unit in a direction intersecting with the first arrangement direction.

The vibration module according to the above aspect of the present invention can be smaller and thinner.

### BRIEF DESCRIPTION OF DRAWINGS

FIG. 1 is a schematic cross-sectional view of a vibration module according to an embodiment and an electronic device incorporating the vibration module.

FIG. 2 is an exploded perspective view of the vibration module.

FIG. 3 is an exploded perspective view of the vibration module.

FIG. 4A is a schematic cross-sectional view of a vibration module in a comparative example and an electronic device.

FIG. 4B is a graph showing the vibration characteristics of the vibration module according to the embodiment and the vibration characteristics of the vibration module in the comparative example.

FIG. 5 is an external perspective view of a vibration module according to a modification.

### DETAILED DESCRIPTION

A vibration module according to one or more embodiments of the present invention will now be described with reference to the drawings.

Vibration modules are included in, for example, electronic devices such as laptop personal computers, tablet mobile information terminals, and in-vehicle displays. Such an electronic device includes a trackpad or a touchpad with an operation surface operable by a user. When the user operates the trackpad or the touchpad by touching or swiping the operation surface with a finger, the vibration module is driven to vibrate the trackpad or the touchpad. In other words, the trackpad or the touchpad provides haptic feedback to the user in response to a user operation.

### Embodiments

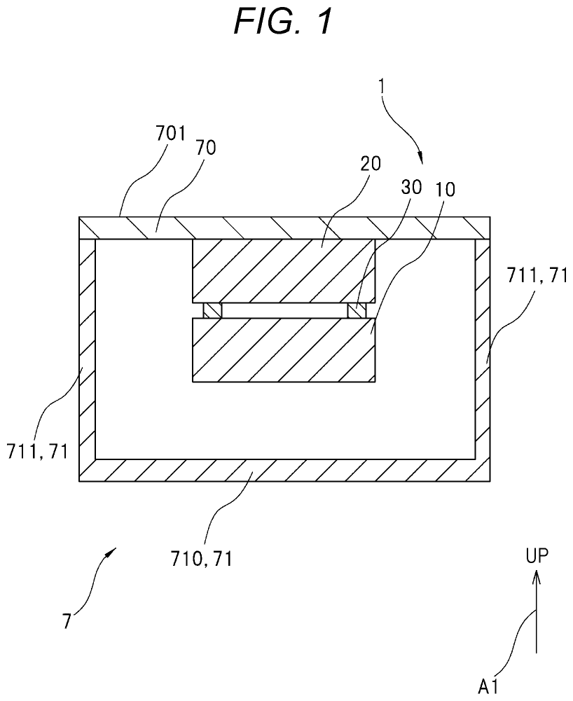

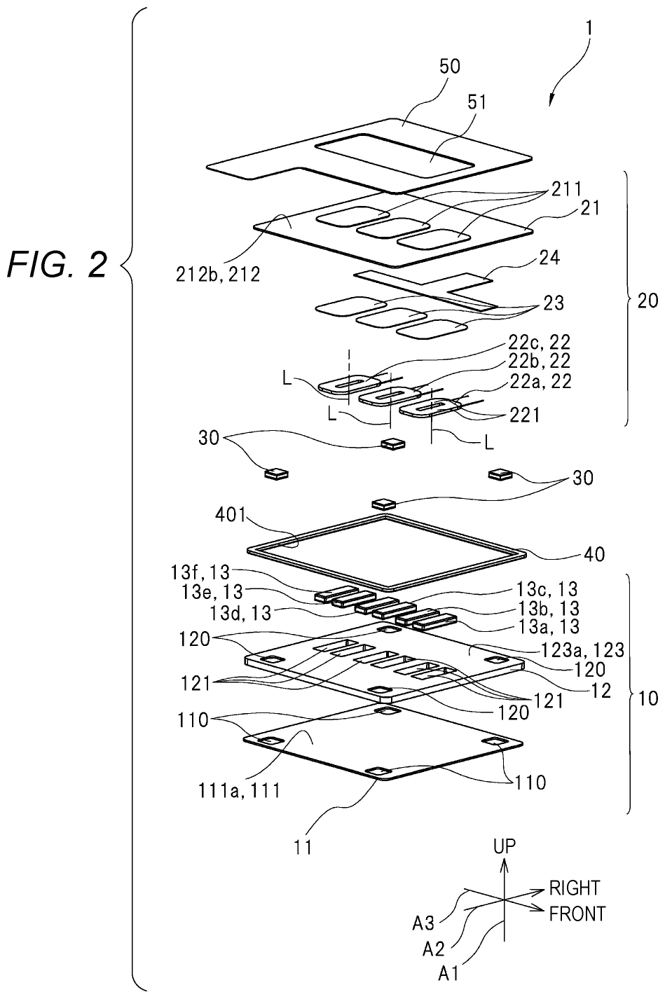

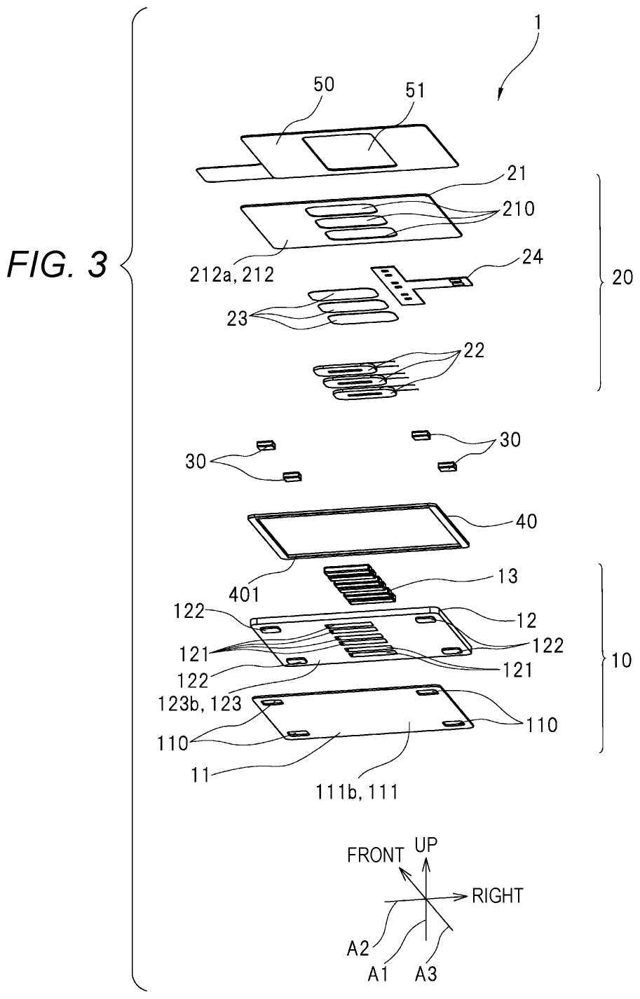

FIG. 1 is a schematic sectional view of a vibration module 1 according to an embodiment and an electronic device 7 incorporating the vibration module 1. FIGS. 2 and 3 are exploded perspective views of the vibration module 1 according to the embodiment.

### Electronic Device 7

The electronic device 7 includes a vibration body 70 and a support 71. The vibration body 70 is, for example, an operation surface operable by the user, such as the trackpad or the touchpad described above. The vibration body 70 has an operation surface 701 on which a position detection sensor is installed. The position detection sensor is flat. The position detection sensor is, for example, a capacitive sensor and detects the two-dimensional position of a finger of the user in contact with the operation surface 701. A pressure-sensitive sensor is also installed on the operation surface 701 to detect a pressing operation on the operation surface 701 performed by the user. Signals output from the position detection sensor and the pressure-sensitive sensor are input into a controller included in the electronic device 7.

The vibration body 70, to which the vibration module 1 is attached, is vibrated by the vibration module 1. More specifically, when the user operates the operation surface 701 of the vibration body 70, the vibration module 1 is driven in response to the signals output from the position detection sensor and the pressure-sensitive sensor to vibrate the vibration body 70. The vibration is transmitted to the finger of the user through the operation surface 701, providing haptic feedback to the user.

The support 71 is a frame or another member that supports the vibration body 70 to allow vibration and is incorporated in the electronic device 7. The support 71 has a facing surface 710 facing the vibration body 70 and side surfaces 711 that extend from the facing surface 710 to the vibration body 70 and connect to the vibration body 70. The vibration module 1 attached to the vibration body 70 is not in contact with the facing surface 710 and the side surfaces 711. In other words, a space is defined between the vibration module 1 and the facing surface 710 and between the vibration module 1 and the side surfaces 711.

### Vibration Module 1

The vibration module 1 includes a movable unit 10, a stationary unit 20, elastic members 30, a protector 40, and an attachment member 50. The movable unit 10, the stationary unit 20, the elastic members 30, the protector 40, and the attachment member 50 are arranged in a first arrangement direction A1 indicated by the arrows in FIGS. 1 to 3. The direction toward a starting point in the first arrangement direction A1 shown in FIGS. 1 to 3 may be referred to as being lower or downward. The direction toward a distal end in the first arrangement direction A1 may be referred to as being upper or upward. The first arrangement direction A1 may be referred to as a vertical direction. FIG. 2 is an exploded perspective view of the vibration module 1 as viewed from above. FIG. 3 is an exploded perspective view of the vibration module 1 as viewed from below. The vibration module 1 is attached to a lower surface of the vibration body 70.

### Movable Unit 10

The movable unit 10 moves relative to the stationary unit 20 in a direction intersecting with the first arrangement direction A1 when coils 22 included in the stationary unit 20 (described later) are energized. Hereafter, a direction intersecting with the first arrangement direction A1 is referred to as an intersecting direction A2, and a direction intersecting with the first arrangement direction A1 and the intersecting direction A2 is referred to as a second arrangement direction A3. Hereafter, the direction toward a starting point in the intersecting direction A2 may be referred as being leftward, and the direction toward a distal end in the intersecting direction A2 may be referred to as being rightward. The direction toward a starting point in the second arrangement direction A3 may be referred as being rearward, and the direction toward a distal end in the second arrangement direction A3 may be referred to as being frontward.

In the present embodiment, the movable unit 10 may move relative to the stationary unit 20 in the second arrangement direction A3. The movable unit 10 includes a back yoke 11, a base plate 12, and magnets 13.

### Back Yoke 11

The back yoke 11 is a flat plate member formed from, for example, a high-permeability material such as iron or steel. The back yoke 11 has a surface 111 being rectangular with two sides in the intersecting direction A2 and two sides in the second arrangement direction A3. The surface 111 includes a surface 111a at an upper side in the first arrangement direction A1 and a surface 111b at a lower side in the first arrangement direction A1. The surface 111 of the back yoke 11 has through-holes 110 adjacent to the respective four corners. The through-holes 110 extend through the back yoke 11 in the vertical direction.

### Base Plate 12

The base plate 12 is a flat plate member formed from, for example, stainless steel such as a non-magnetic SUS material. The base plate 12 has a surface 123 being rectangular with two sides in the intersecting direction A2 and two sides in the second arrangement direction A3. The surface 123 includes a surface 123a at an upper side in the first arrangement direction A1 and a surface 123b at a lower side in the first arrangement direction A1. The base plate 12 has the same or substantially the same dimension (thickness) in the vertical direction as the magnets 13 (described later).

The base plate 12 is located above the back yoke 11. In other words, the surface 123b of the base plate 12 is attached to the upper surface of the surface 111a of the back yoke 11. The base plate 12 includes receiving portions 120 and magnet reception holes 121. The receiving portions 120 are located adjacent to the respective four corners of the surface 123a of the base plate 12 and each receive the corresponding elastic member 30 (described later). The receiving portions 120 are recesses on the surface 123a of the base plate 12. The surface 123b of the base plate 12 includes attachment protrusions 122 protruding downward aligned with the receiving portions 120. In other words, the receiving portions 120 and the attachment protrusions 122 overlap the through-holes 110 in the back yoke 11 in the vertical direction. Thus, when the base plate 12 is placed on the back yoke 11, the attachment protrusions 122 are received in the through-holes 110. In other words, the attachment protrusions 122 and the through-holes 110 are used for positioning in attaching the base plate 12 to the back yoke 11.

The magnet reception holes 121 are located near the center of the surface 123 of the base plate 12 and each accommodate the corresponding magnet 13. The magnet reception holes 121 are through-holes extending through the base plate 12 in the vertical direction. The base plate 12 has as many magnet reception holes 121 as the magnets 13 (described later). In FIG. 2, six magnet reception holes 121 are located. Each magnet reception hole 121 is a rectangular through-hole having long sides in the intersecting direction A2 and short sides in the second arrangement direction A3. The multiple magnet reception holes 121 are arranged in the second arrangement direction A3. In other words, the multiple magnet reception holes 121 are arranged in the direction in which their short sides extend. The base plate 12 thus has the multiple magnet reception holes 121 without increasing its dimension in the second arrangement direction A3.

The magnet reception holes 121 are shaped and arranged based on the shape and the arrangement of the magnets 13 (described later). The magnet reception holes 121 may not be rectangular. The multiple magnet reception holes 121 may not be arranged in the second arrangement direction A3.

### Magnet 13

Each magnet 13 is a prism having a bottom surface and an upper surface each being rectangular with long sides in the intersecting direction A2 and short sides in the second arrangement direction A3. The magnet 13 may have any dimension (thickness) in the vertical direction. To prevent the vibration module 1 from being larger in the vertical direction, the magnet 13 may have a smaller thickness (may be thinner) within a range that allows automatic processing. In the present embodiment, the magnet 13 can be 1 mm thick or less.

Multiple magnets 13 are arranged on the back yoke 11 in the second arrangement direction A3. More specifically, as shown in FIG. 2, six magnets 13a, 13b, 13c, 13d, 13e, and 13f are arranged in the second arrangement direction A3. In other words, the multiple magnets 13 are arranged in the direction in which their short sides extend. Thus, the vibration module 1 with the multiple magnets 13 being arranged is less likely to increase its dimension in the second arrangement direction A3.

The magnets 13 are accommodated in the respective magnet reception holes 121 in the base plate 12 described above. Each magnet 13 has a lower surface fixed to the surface 111a of the back yoke 11 by, for example, bonding. The multiple magnets 13 aligned in the second arrangement direction A3 include adjacent magnets 13 having upper surfaces with different magnetic poles (the S pole and the N pole).

### Stationary Unit 20

The stationary unit 20 is located above the movable unit 10 and is attached to the lower surface of the vibration body 70. The stationary unit 20 includes a frame 21, coils 22, insulators 23, and a substrate 24.

### Frame 21

The frame 21 is a plate member that supports the coils 22 and the insulators 23. The frame 21 has a surface 212 being rectangular with two sides in the intersecting direction A2 and two sides in the second arrangement direction A3. The surface 212 includes a first surface 212a at a lower side (one side) of the surface 212 in the first arrangement direction A1 and a second surface 212b at an upper side (the other side) of the surface 212 in the first arrangement direction A1. The first surface 212a of the frame 21 thus faces the surface 123a at the upper side of the base plate 12 in the movable unit 10 located below.

The frame 21 includes coil receiving portions 210 near the center of the surface 212. The coil receiving portions 210 are recesses on the first surface 212a of the frame 21. The coil receiving portions 210 accommodate the coils 22 and the insulators 23 that are fixed by, for example, bonding. The coils 22 and the insulators 23 are thus supported by the frame 21. The coil receiving portions 210 on the first surface 212a of the frame 21 protrude upward on the second surface 212b of the frame 21 as protrusions 211 at positions overlapping the coil receiving portions 210 in the vertical direction. Each protrusion 211 protrudes upward by an amount (dimension) equal to or substantially equal to the thickness (the dimension in the vertical direction) of the attachment member 50 (described later).

### Coil 22

The coils 22 are accommodated in the coil receiving portions 210 in the first surface 212a of the frame 21 with the insulators 23 (described later) between them and are attached by, for example, bonding. Each coil 22 is an air-cored flat coil that is flat in a coil axis direction L. The coils 22 are arranged with the coil axis direction L being parallel to or substantially parallel to the first arrangement direction (vertical direction) A1. The flat coils 22 accommodated in the coil receiving portions 210, which are the recesses, allow the stationary unit 20 to have a smaller dimension (thickness) in the vertical direction and thus allow the vibration module 1 to be thinner in the vertical direction.

Each coil 22 is elliptical and has two effective sides 221 being long sides in the intersecting direction A2. Three coils 22a, 22b, and 22c are located below the frame 21 in the second arrangement direction A3. In other words, the effective sides 221 of each coil 22 are arranged in the second arrangement direction A3. Thus, the frame 21 described above includes three coil receiving portions 210 aligned in the second arrangement direction A3.

Each coil 22 faces two of the multiple magnets 13 described above. More specifically, the coil 22a has one effective side 221 facing the magnet 13a and the other effective side 221 facing the magnet 13b. The coil 22b has one effective side 221 facing the magnet 13c and the other effective side 221 facing the magnet 13d. The coil 22c has one effective side 221 facing the magnet 13e and the other effective side 221 facing the magnet 13f.

As described above, the multiple magnets 13 aligned in the second arrangement direction A3 each have an upper surface with a magnetic pole different from the magnetic poles of adjacent magnets 13. Thus, each coil 22 faces two magnets 13 with different polarities. Switching the direction of a current flowing through each coil 22 can vibrate the movable unit 10 in the second arrangement direction A3. In other words, the movable unit 10 moves in the second arrangement direction A3 in which the multiple magnets 13 and the multiple coils 22 are arranged.

### Insulator 23

The insulators 23 are formed from an insulating material (e.g., a resin material). The insulators 23 are three insulators in total, corresponding one-to-one to the three coils 22. The insulators 23 are located between the coils 22 and the first surface 212a of the frame 21.

### Substrate 24

The substrate 24 is a flexible printed circuit (FPC) board. The substrate 24 has a part located inside the stationary unit 20, and another part extending outside the stationary unit 20. The part of the substrate 24 inside the stationary unit 20 is electrically connected to the coils 22. The other part of the substrate 24 outside the stationary unit 20 is electrically connected to, for example, an external power circuit. Thus, power is supplied from an external device to the coils 22 through the substrate 24, and a current flows through the coils 22.

### Elastic Member 30

The elastic members 30 are prisms formed from, for example, a resin material such as silicone and extend in the first arrangement direction A1. The elastic members 30 are located between the movable unit 10 and the stationary unit 20. More specifically, the elastic members 30 are accommodated in the receiving portions 120 in the base plate 12 in the movable unit 10 described above. In other words, the vibration module 1 includes four elastic members 30. Each elastic member 30 has a lower surface fixed to the base plate 12 with, for example, an adhesive. The elastic member 30 has an upper surface fixed to the first surface 212a of the frame 21 in the stationary unit 20 with, for example, an adhesive.

As described above, the elastic members 30 are accommodated in the receiving portions 120, which are the recesses on the base plate 12. Thus, the elastic members 30 can have a larger dimension (thickness) in the vertical direction by the dimension (depth) of the receiving portions 120 in the vertical direction without increasing the thickness of the vibration module 1 in the vertical direction.

When the movable unit 10 moves in the second arrangement direction A3 as described above, the elastic members 30 are elastically deformed in the second arrangement direction A3 in which the movable unit 10 moves, and urge the movable unit 10 in the direction opposite to the direction of its movement. The elastic members 30 thus support the base plate 12 in the movable unit 10 to allow vibration with respect to the frame 21 in the stationary unit 20.

As described above, the elastic members 30 each have a larger thickness in the vertical direction than an elastic member 30 located on a base plate 12 including no receiving portion 120. Thus, the elastic members 30 are more flexible (less rigid) than the elastic members 30 located without receiving portions 120. This lowers the resonant frequency of the elastic members 30 and prevents the vibration acceleration of the movable unit 10 from decreasing steeply.

### Protector 40

The protector 40 is formed from an elastic material such as rubber or urethane. The protector 40 is frame-like and extends along the periphery of the surface 123a of the base plate 12 in the movable unit 10. The protector 40 is located between the movable unit 10 and the stationary unit 20. More specifically, the protector 40 is fixed to the upper surface of the base plate 12 in the movable unit 10 by, for example, bonding. This can reduce a space between the movable unit 10 and the stationary unit 20 in the vertical direction. The frame-like protector 40 allows the receiving portions 120 and the magnet reception holes 121 in the base plate 12 to be located inward from an inner wall surface 401 of the protector 40. In other words, the elastic members 30 accommodated in the receiving portions 120, the magnets 13 accommodated in the magnet reception holes 121, and the coils 22 facing the magnets 13 are located inward from the protector 40. This structure can reduce adverse effects on the operations of the magnets 13 and the coils 22 caused by foreign objects such as dust entering inside the vibration module 1.

The protector 40 formed from an elastic material also functions as a shock absorber when the vibration module 1 receives a shock, and protects the vibration module 1. The vibration module 1 thus has higher durability.

### Attachment Member 50

The attachment member 50 is a member for attaching the vibration module 1 on the vibration body 70 and is, for example, double-sided adhesive tape. The attachment member 50 has a lower surface attached to the second surface 212b of the frame 21 in the stationary unit 20 described above. The attachment member 50 has an opening 51. The opening 51 surrounds the protrusions 211 on the second surface 212b of the frame 21 described above when the attachment member 50 is attached to the second surface 212b of the frame 21. When an adhesive is poured into the opening 51, a space defined by the opening 51, the protrusions 211, and the second surface 212b of the frame 21 receives the adhesive. The attachment member 50 thus has higher bonding strength.

The attachment member 50 has an upper surface attached to the lower surface of the vibration body 70. In other words, the frame 21 is attached to the lower surface of the vibration body 70 with the attachment member 50 located between the frame 21 and the vibration body 70. In this manner, the vibration module 1 is attached to the lower surface of the vibration body 70 with the upper surface alone.

### Operation of Vibration Module 1

As described above, one coil 22 faces two adjacent magnets 13. The coil 22 faces the magnetic poles of different polarities (the S pole and the N pole) of the two adjacent magnets 13. When the coil 22 is not energized, the base plate 12 is at a neutral stable position at which the center of the surface 111 matches or substantially matches the center of the surface 212 of the frame 21. In this case, the coil 22 has one effective side 221 facing the S pole of one magnet 13 and the other effective side 221 facing the N pole of the other magnet 13.

The coil 22 energized through the substrate 24 as described above is excited to generate a magnetic field that acts on the magnets 13. In the energized coil 22, a current flows in opposite directions in the two adjacent effective sides 221 arranged in the second arrangement direction A3. Thus, one effective side 221 of the coil 22 generates a magnetic field having a direction opposite to the direction of the magnetic field generated by the other effective side 221. With one effective side 221 of the coil 22 facing the S pole of one magnet 13 and the other effective side 221 facing the N pole of the other magnet 13, the magnets 13 move either forward or backward in the second arrangement direction A3. This causes the movable unit 10 including the base plate 12 and the back yoke 11 with the magnets 13 to move relative to the stationary unit 20 with the coils 22 either forward or backward in the second arrangement direction A3 intersecting with the first arrangement direction A1.

Switching the direction of a current flowing through the coil 22 switches the direction of the magnetic field generated by one effective side 221 of the coil 22 as well as the direction of the magnetic field generated by the other effective side 221. This switches the direction of the movement of the magnets 13 in the second arrangement direction A3. Thus, the direction of the movement of the movable unit 10 relative to the stationary unit 20 switches in the second arrangement direction A3. Every time the current flowing through the coil 22 repeats switching its direction, the direction of the movement of the movable unit 10 relative to the stationary unit 20 switches, and the movable unit 10 vibrates relative to the stationary unit 20 in the second arrangement direction A3. In other words, the movable unit 10 vibrates in the direction intersecting with the first arrangement direction A1 in which the movable unit 10 and the stationary unit 20 are arranged.

The vibration of the movable unit 10 causes the elastic members 30 to resonate and is transmitted to the stationary unit 20. The vibration is transmitted to the vibration body 70 to which the stationary unit 20 is attached. The vibration body 70 then vibrates, and the user in contact with the vibration body 70 detects vibration.

### Comparative Example

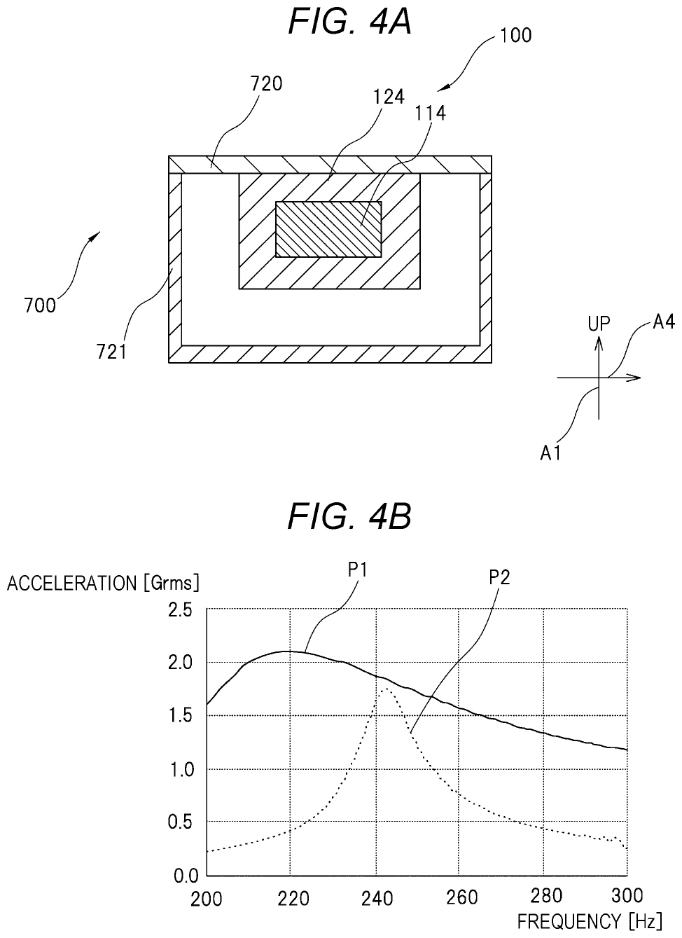

FIG. 4A is a schematic sectional view of a vibration module 100 in a comparative example and an electronic device 700 incorporating the vibration module 100. The vibration module 100 is, for example, a linear resonant actuator (LRA). The vibration module 100 includes a movable unit 114 and a stationary unit 124. In the vibration module 100, the stationary unit 124 has an upper surface attached to a lower surface of a vibration body 720 supported by a support 721 in the electronic device 700. When the vibration module 100 is energized, the movable unit 114 vibrates in a direction A4 intersecting with the first arrangement direction A1 in which the movable unit 114 and the stationary unit 124 are arranged. This vibrates the vibration body 720.

FIG. 4B is a graph showing the vibration characteristics of the vibration module 1 according to the embodiment and the vibration characteristics of the vibration module 100 in the comparative example. In FIG. 4B, the horizontal axis indicates the resonant frequency (in Hz) of vibration generated by the vibration modules 1 and 100 in a range of 200 to 300 Hz. The vertical axis indicates the acceleration (in Grms) of vibrations of the vibration modules 1 and 100. In FIG. 4B, vibration characteristics P1 shown with the solid line are the vibration characteristics of the vibration module 1 according to the embodiment, and vibration characteristics P2 shown with the broken line is the vibration characteristics of the vibration module 100 in the comparative example.

As shown with the vibration characteristics P2 in FIG. 4B, the acceleration of the vibration of the vibration module 100 in the comparative example suddenly increases when the frequency is about 230 Hz or higher, reaches a peak of about 1.7 Grms at around a frequency exceeding 240 Hz, and then decreases suddenly.

For the vibration module 1 according to the embodiment, as shown with the vibration characteristics P1, the acceleration reaches a peak of about 2.1 Grms at a resonant frequency of about 220 Hz. The vibration module 1 according to the embodiment includes less rigid elastic members 30 as described above, and thus can vibrate in a wide frequency range (wideband) with the acceleration of the vibration being less likely to decrease steeply.

The acceleration of the vibration of the vibration module 1 is, over the full range described above, greater than 1.7 Grms, which is the peak value of the acceleration of the vibration of the vibration module 100 in the comparative example. In other words, the vibration module 1 according to the embodiment vibrates with greater acceleration than the vibration module 100 in the comparative example with a frequency in a range of 300 Hz or lower that is known to be more detectable by humans. The vibration module 1 according to the embodiment includes the less rigid elastic members 30, and thus the vibration generated by the multiple magnets 13 and the multiple coils 22 are reduced by a lesser degree before being transmitted to the vibration body 70. Thus, the vibration module 1 achieves high vibration, allowing the user to detect the vibration of the electronic device 7 more easily. The vibration module 1 can vibrate in a wide frequency range with the vibration being reduced by a lesser degree. Thus, the user can detect vibrations of different frequencies with high amplitude.

The structure according to the above embodiment produces at least one of the advantageous effects described below.

(1) The vibration module 1 includes the movable unit 10, the stationary unit 20, and the elastic members 30 arranged in the first arrangement direction A1. The frame 21 in the stationary unit 20 has, at one side of the frame 21 in the first arrangement direction A1, the first surface 212a that is attached to the movable unit 10 with the elastic members 30. The frame 21 in the stationary unit 20 has, at the other side of the frame 21 in the first arrangement direction A1, the second surface 212b that is attached to the vibration body 70 supported by the support 71. The elastic members 30 allow vibration of the movable unit 10 to be reduced by a lesser degree, and the vibration module 1 can vibrate in a wide frequency range (wideband) with high amplitude. Thus, for example, a single vibration module 1 can generate multiple vibrations with different frequencies and high amplitude. In other words, the single vibration module 1 can cause the user to detect different types of vibrations that generate different tactile sensations. With the vibration module 1 that can vibrate with high amplitude, a larger vibration body 70 can be vibrated without increasing the number of vibration modules 1 attached to the vibration body 70. The movable unit 10 in the vibration module 1 moves relative to the stationary unit 20 in the second arrangement direction A3 intersecting with the first arrangement direction A1. Thus, in comparison with a movable unit that moves in the first arrangement direction A1, the vibration module 1 has a smaller thickness in the vertical direction and is downsized.

(2) The base plate 12 has the surface 123a facing the first surface 212a of the frame 21. The surface 123a includes the receiving portions 120 being the recesses for accommodating the elastic members 30. Each elastic member 30 can have a larger dimension in the vertical direction without increasing the dimension of the vibration module 1 in the vertical direction, thus downsizing the device. Each elastic member 30 with a larger dimension in the vertical direction can be less rigid, and vibration of the movable unit 10 is thus reduced by a lesser degree. The vibration module 1 can thus vibrate in a wide frequency range (wideband) with high amplitude.

(3) The vibration module 1 includes the protector 40 located between the base plate 12 and the frame 21. The protector 40 is frame-like and extends along the periphery of the base plate 12. The magnets 13, the coils 22, and the elastic members 30 are located inward from the protector 40. This structure can reduce adverse effects on the operations of the magnets 13 and the coils 22 caused by foreign objects such as dust entering inside the vibration module 1.

(4) The vibration module 1 includes the attachment member 50 located between the second surface 212b of the frame 21 and the vibration body 70. The attachment member 50 attaches the frame 21 to the vibration body 70. The second surface 212b of the frame 21 includes the protrusions 211 protruding toward the vibration body 70. The attachment member 50 has the opening 51 accommodating the protrusions 211. With the protrusions 211 being accommodated in the opening 51, the amounts by which the protrusions 211 protrude upward, or in other words, the thicknesses of the coils 22 and the insulators 23, are offset by the thickness of the attachment member 50. The vibration module 1 is thus less likely to be larger in the vertical direction. When an adhesive is poured into the opening 51, a space defined by the opening 51, the protrusions 211, and the second surface 212b of the frame 21 receives the adhesive, allowing the attachment member 50 to have higher bonding strength.

(5) The base plate 12 includes the attachment protrusions 122 protruding toward the back yoke 11. The attachment protrusions 122 are placed in the through-holes 110 in the back yoke 11. This facilitates positioning in attaching the base plate 12 to the back yoke 11. With the attachment protrusions 122 placed in the through-holes 110, the vibration module 1 is less likely to be larger in the vertical direction.

(6) The multiple magnets 13 and the multiple coils 22 are arranged in the second arrangement direction A3 intersecting with the first arrangement direction A1. This can increase the acceleration of the vibration of the vibration module 1, allowing the user to detect the vibration of the electronic device 7 more easily.

(7) The surface 123a of the base plate 12 has the magnet reception holes 121 being reception holes accommodating the respective magnets 13. The magnet reception holes 121 are arranged in the second arrangement direction A3. The thicknesses of the magnets 13 in the vertical direction are offset by the thickness of the base plate 12, thus downsizing the vibration module 1 in the vertical direction.

### Modifications

The stationary unit 20 included in the vibration module 1 may not include the frame 21 in the embodiment described above.

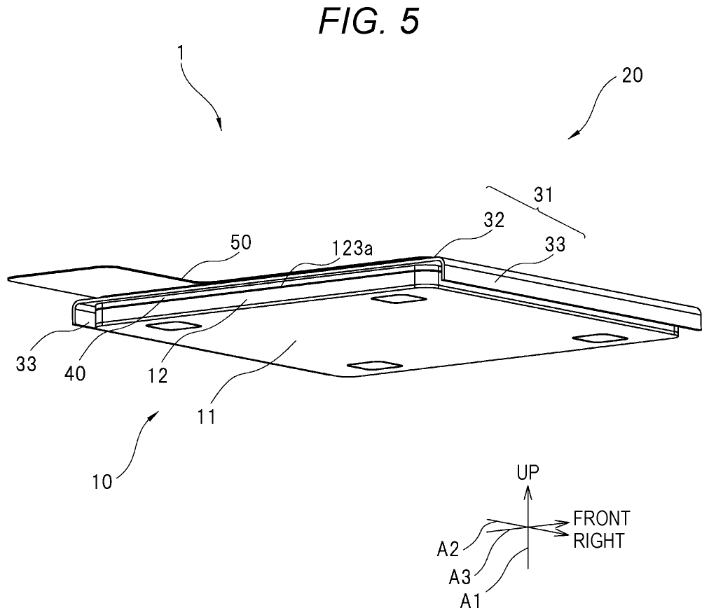

FIG. 5 is an external perspective view of a vibration module 1 according to a modification. A stationary unit 20 included in the vibration module 1 according to the modification includes a frame 31 having a surface 32 and side surfaces 33. The surface 32 is a plate similar to the surface 212 of the frame 21 in the embodiment and is rectangular with two sides in the intersecting direction A2 and two sides in the second arrangement direction A3. The surface 32 is larger than the surface 123 of the base plate 12 in the movable unit 10.

The side surfaces 33 connect to the front side and the rear side of the surface 32 and extend downward in the first arrangement direction A1. In other words, each side surface 33 has an upper end face connecting to the surface 32. In the first arrangement direction A1, each side surface 33 has a lower end face located downward from the surface 123a at the upper side of the base plate 12 in the movable unit 10. The side surfaces 33 can thus cover spaces between the movable unit 10 and the stationary unit 20 at the front and the rear in the vertical direction, reducing foreign objects such as dust entering inside the vibration module 1. With the surface 32 larger than the base plate 12 in the movable unit 10, the side surfaces 33 are less likely to interfere with the movable unit 10 moving relative to the stationary unit 20. In other words, the vibration module 1 according to the modification can also demonstrate the same or similar vibration characteristics as the vibration module 1 according to the embodiment.

In a performance test performed after the vibration module 1 is manufactured, the coils 22 can be energized with a fixture or another tool holding the side surfaces 33. The state of vibration of the movable unit 10 can be measured.

Although the side surfaces 33 are located at the front and the rear of the surface 32 in the modification described above, the side surfaces 33 may be located at the right and the left of the surface 32.

The modification produces advantageous effects below in addition to at least one of the advantageous effects produced by the embodiment described above.

(8) The frame 31 has the surface 32 being plate-like and the side surfaces 33 extending in the first arrangement direction A1. Each side surface 33 has the upper end face being one end face connecting to the surface 32. This structure can reduce foreign objects such as dust entering inside the vibration module 1.

The technique according to one or more embodiments may provide the structure described below.

(1) A vibration module, comprising:
a movable unit including a base plate, a magnet, and a back yoke;
a stationary unit including a frame, a substrate, a coil, and an insulator; and
an elastic member between the movable unit and the stationary unit,
wherein the movable unit, the stationary unit, and the elastic member are arranged in a first arrangement direction,
the frame in the stationary unit has a first surface at one side of the frame in the first arrangement direction and attached to the movable unit with the elastic member, and the frame has a second surface at the other side of the frame in the first arrangement direction and attachable to a vibration body supported by a support, and
the movable unit is movable relative to the stationary unit in a direction intersecting with the first arrangement direction.

(2) The vibration module according to (1), wherein
the base plate has a surface facing the first surface of the frame, and
the surface of the base plate has a recess accommodating the elastic member.

(3) The vibration module according to (1) or (2), further comprising:
a protector between the base plate and the frame, the protector being frame-like and extending along a periphery of the base plate,
wherein the magnet, the coil, and the elastic member are located inward from the protector.

(4) The vibration module according to any one of (1) to (3), further comprising:
an attachment member to be located between the second surface of the frame and the vibration body to attach the frame to the vibration body,
wherein the second surface of the frame includes a protrusion protruding toward the vibration body, and
the attachment member has an opening accommodating the protrusion.

(5) The vibration module according to any one of (1) to (4), wherein
the base plate includes an attachment protrusion protruding toward the back yoke, and
the attachment protrusion is placed in a through-hole in the back yoke.

(6) The vibration module according to any one of (1) to (5), wherein
a plurality of the magnets and a plurality of the coils are arranged in a second arrangement direction intersecting with the first arrangement direction, and
the movable unit moves relative to the stationary unit in the second arrangement direction.

(7) The vibration module according to (6), wherein
the base plate has a surface facing the first surface of the frame,
the surface of the base plate has a plurality of reception holes each accommodating a corresponding magnet of the plurality of magnets, and
the plurality of reception holes are arranged in the second arrangement direction.

(8) The vibration module according to any one of (1) to (7), wherein
the frame has a surface being plate-like and a side surface extending in the first arrangement direction, and
the side surface has one end face connecting to the surface of the frame.

What is claimed is:

1. A vibration module, comprising:
a movable unit including a base plate, a magnet, and a back yoke;
a stationary unit including a frame, a substrate, a coil, and an insulator; and
an elastic member between the movable unit and the stationary unit,
wherein the movable unit, the stationary unit, and the elastic member are arranged in a first arrangement direction,
the frame in the stationary unit has a first surface at one side of the frame in the first arrangement direction and attached to the movable unit with the elastic member, and the frame has a second surface at the other side of the frame in the first arrangement direction and attachable to a vibration body supported by a support, and
the movable unit is movable relative to the stationary unit in a direction intersecting with the first arrangement direction.

2. The vibration module according to claim 1, wherein
the base plate has a surface facing the first surface of the frame, and
the surface of the base plate has a recess accommodating the elastic member.

3. The vibration module according to claim 1, further comprising:
a protector between the base plate and the frame, the protector being frame-like and extending along a periphery of the base plate,
wherein the magnet, the coil, and the elastic member are located inward from the protector.

4. The vibration module according to claim 1, further comprising:
an attachment member to be located between the second surface of the frame and the vibration body to attach the frame to the vibration body,
wherein the second surface of the frame includes a protrusion protruding toward the vibration body, and
the attachment member has an opening accommodating the protrusion.

5. The vibration module according to claim 1, wherein
the base plate includes an attachment protrusion protruding toward the back yoke, and
the attachment protrusion is placed in a through-hole in the back yoke.

6. The vibration module according to claim 1, wherein
a plurality of the magnets and a plurality of the coils are arranged in a second arrangement direction intersecting with the first arrangement direction, and
the movable unit moves relative to the stationary unit in the second arrangement direction.

7. The vibration module according to claim 6, wherein
the base plate has a surface facing the first surface of the frame,
the surface of the base plate has a plurality of reception holes each accommodating a corresponding magnet of the plurality of magnets, and
the plurality of reception holes are arranged in the second arrangement direction.

8. The vibration module according to claim 1, wherein
the frame has a surface being plate-like and a side surface extending in the first arrangement direction, and
the side surface has one end face connecting to the surface of the frame.
